(19) United States
(12) Patent Application Publication
(10) Pub. No.: US 2004/0040026 A1
(43) Pub. Date: Feb. 26, 2004

(54) Method and System of Linking a Smart Device Description File with the Logic of an Application Program

(75) Inventor: Augustin Farrugia, Los Altos, CA (US)

Correspondence Address: BURNS DOANE SWECKER & MATHIS L L P, POST OFFICE BOX 1404, ALEXANDRIA, VA, 22313-1404, US

(73) Assignee: ThinkPulse, Inc., Redwood City, CA (US)

(21) Appl. No.: 09/328,058

(22) Filed: Jun. 8, 1999

(51) Int. Cl. G06F 9/00

(52) U.S. Cl. 719/310

(57) ABSTRACT

### Abstract of the Disclosure

A linking engine providing a process of matching the logic of an application, described in a application logic unit, with the hardware specific description of the application for use with applications run on smart card terminals. The hardware specific description of the application is contained in dictionaries. The linking engine tests dictionaries for compatibility with the application logic unit by running a process that returns a predetermined response only when the dictionary describes the hardware implementation used in the test. A dictionary outputting the correct response is linked by the linking engine to provide the description of the hardware implemented in running the logic of the application.

### Detailed Description of the Invention

### Background of Invention

Field of the Invention

The present invention relates to the field of smart devices. More particularly, the present invention relates to the field of application software used in connection with a smart device.

Related Background

Smart devices, such as smart cards, smart watches, smart tags, or other portable objects with the ability to either process data or store data, interface with other processing devices to provide a functional implementation. Examples of functional implementations, or uses, of the smart device include stored value (often referred to as an electronic purse), loyalty award programs, secure access, secure authentication, as well as many other uses.

Figure 1 is a block diagram of a conventional smart device system (1). A smart device (2) is in communication with a terminal (3). Application software that runs on the terminal (3) is often referred to as an application (4). Applications (4) interfaces with the terminal hardware (5) through an Application Programming Interface (API) (6). The API is assembled of smart device interfaces that support applications. Typically, the API runs on top of a layer of software (not shown) which interacts directly with the terminal hardware. Examples of such layers include the Open Card Framework (OCF) layer, the Personal Computer to Smart Card (PC-SC) layer, and the Sun^{TM} initiative layer.

Application software, often referred to as applets (7), for processing data on the smart device (2) run on the smart device and interact with the smart device hardware (8) through the smart device operating system (OS) (9). The application (4) running on the terminal (3) interfaces with the applet (7) through the API (6), terminal hardware (5), and the smart device hardware (8).

Data is downloaded/uploaded to the smart device (2) by the terminal (3). The terminal can be either of the contact or contactless type. In contact type smart devices contact tabs of the terminal establish communication with the smart device through physical contact with contact pads located on the smart device. In contactless terminals radio frequency (RF) is typically used to provide communication with the smart device. Other contactless terminals can use optical, microwave, or other communication methods.

Because memory space is at a premium in terminals, conventional APIs are optimized to support a specific functional implementation of a particular terminal-device combination. For example, an API designed for use with a smart device functioning as an electronic purse is optimized to support those functions commonly used in implementing electronic purse applications. Similarly, an API designed to support loyalty award applications, such as airline frequent flyer rewards program, is optimized to support those functions commonly used in implementing loyalty applications. Electronic purse applications would typically not be interoperable with loyalty APIs as such APIs would not support the electronic purse functionality. Similarly, loyalty applications and applets are typically not interoperable with electronic purse APIs. In this manner applications intended for a given functional implementation, such as loyalty, are typically only interoperable with APIs for the same functional implementation.

APIs are typically optimized to work with a particular smart device from a particular manufacturer. An API for a particular manufacturer"s electronic purse smart device supports different application functionalities than an electronic purse API designed for another manufacturer"s smart device. Additionally, even different models of electronic purse smart devices from a particular manufacturer may require a different APIs that are not interoperable with applications written for the other models of electronic purse smart devices from the same manufacturer. APIs are also typically optimized to work with a particular reader. Thus, an application written for a given API may be capable of being used with a small subset of available smart devices in combination with a particular set of readers. This results in a lack of interoperability of applications written for loyalty across APIs for cards from different manufacturers and for particular terminals.

This lack of interoperability of applications across the proliferation of APIs optimized for specific smart devices, terminals and functionalities reduces the ability for developers to create applications that can be implemented on a wide variety of smart devices. The present design of conventional APIs requires developers to write and develop applications for use with a specific, or a specific set, of APIs. Consequently, applications written in this manner are only useful with a limited number of smart devices and terminals.

Existing programming interfaces have attempted to solve the problems associated with the lack of flexibility with conventional APIs. One attempt at providing greater interoperability among applications and APIs is the Java programming language.

Figure 2 is a block diagram illustrating the architecture of a typical Java^{TM} card system (10). A Java card (11) is a conventional smart device that may run Java applets (12). Java applets (12) are executed by the smart card Java card virtual machine (JCVM) (13). The JCVM (13) runs on top of the smart card"s OS (14). The OS (14) interfaces with the hardware (15) of the smart card. Java applications (16) run on the JVM (17) of the terminal (18). The terminal (18) is in communication with the Java card (11) can be either a contact or contactless terminal. Applications interface with the hardware of the terminal (19), the hardware of the Java card, and the Java applet through the API (20). Like the API (6) of Figure 1, the API (20) interfaces with the application to support the functionality of the intended use of the Java card. Because of the premium on memory of the terminal, the API typically is optimized to support the functionality for the intended use of the smart card. Thus, an API optimized for electronic purse applets would typically not be able to support loyalty applications. Similarly, an API optimized for loyalty would not be able to support electronic purse applications. In this manner, the Java card has the same disadvantages of the conventional smart card architecture shown in Figure 1.

Attempts to allow interoperability of applications, in either the conventional architecture of Figure 1, or the Java card architecture of Figure 2, result in a loss of supporting functions for applications written for the intended use of the card. The architectures of the presently available smart card systems force designers to make a trade off between interoperability and functionality, with most systems choosing functionality over interoperability.

Attempts to increase the interoperability of conventional APIs by increasing the functions the API supports has the disadvantage of increasing the footprint of the API, i.e. the memory required to store the API on the terminal. This has the disadvantage of increasing the cost and complexity of the terminal.

The conventional architecture of applications and APIs also has the disadvantage that when a new smart device or terminal is introduced, often with a new functionality, existing applications often are not interoperable with an API intended for the new smart device or terminal. An API released prior to the development of the new functionality would not support new functionalities.

### Summary of Invention

The present invention provides a linking engine for smart devices which links the logic of the application, the application logic unit, to a hardware specific description of the application, the application protocol. An application logic unit is written in a conventional computer language and expresses the logic of the application without regard for the specific hardware implementation of the terminal and smart device. During run time the linking engine looks up the appropriate dictionaries corresponding to the hardware elements. Each dictionary has a boot process which, when run, outputs a predetermined response when the hardware used is the hardware the dictionary describes. In this manner dictionaries retrieved from a set of dictionaries are tested to find the dictionary appropriate for the terminal and smart device present when the application logic unit is to be run.

### Brief Description of Drawings

Figure 1 is a block diagram depicting the application system architecture of a conventional smart card.

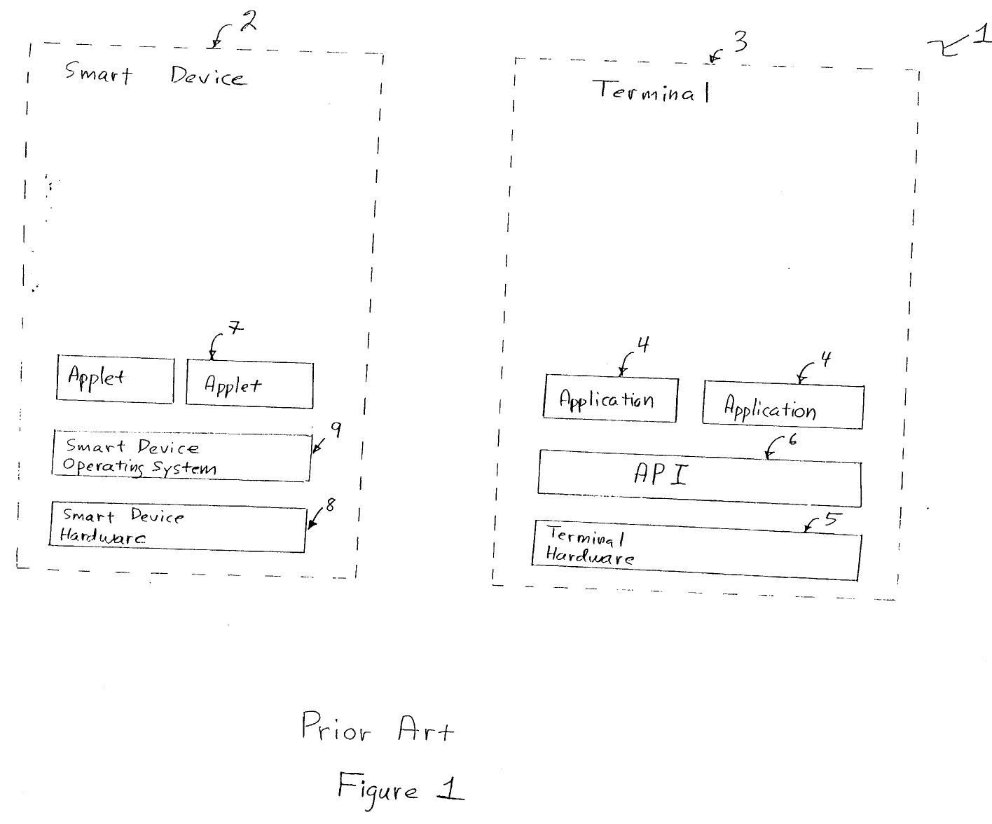

Figure 2 is a block diagram depicting the application system architecture of a conventional Java^{TM} card system.

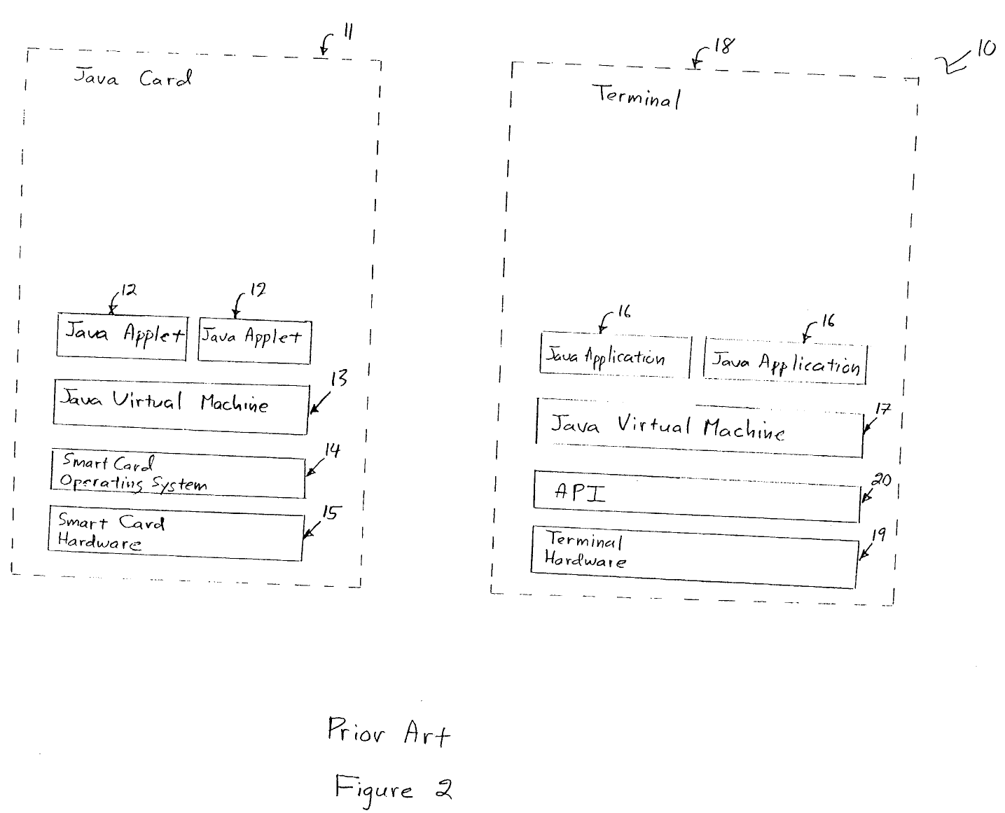

Figure 3 is a block diagram of an application for the smart device including an application logic unit and an application protocol, in accordance with the present invention.

Figure 4 depicts the architecture of the application and linking engine, in accordance with the present invention.

Figure 5 is a flow chart illustrating the process implemented by the linking engine in running the application, in accordance with the present invention.

Figure 6 is a flow chart illustrating the process of selecting the appropriate dictionary for the hardware implementation used at the run time of the application logic unit, in accordance with the present invention.

Figure 7 is flow chart illustrating the process of running an application in accordance with the present invention.

### Detailed Description

The present invention is described in the context of a specific embodiment. This is done to facilitate the understanding of the features and principles of the present invention and the present invention is not limited to this embodiment. In particular, the present invention is described in the context of a smart device. Examples of smart devices applicable to the present invention include, without limitation, smart cards, smart watches, smart tags, smart wristbands, and smart pendants. Smart devices can be either of the processor type, where the device has the ability to run applets to process data, or of the memory type, where the device is sued to store data. Additionally, the present invention is described in the context of a terminal. A terminal can be any computing device capable, by itself or with other devices, of communicating with a smart device. Examples of terminals include, without limitation, personal computers, server computers, hand-held computers, point of sale terminals, portable phones and communication devices, and computer networks.

In the following figures like objects are provided with the same identifying number as an aid in understanding the present invention.

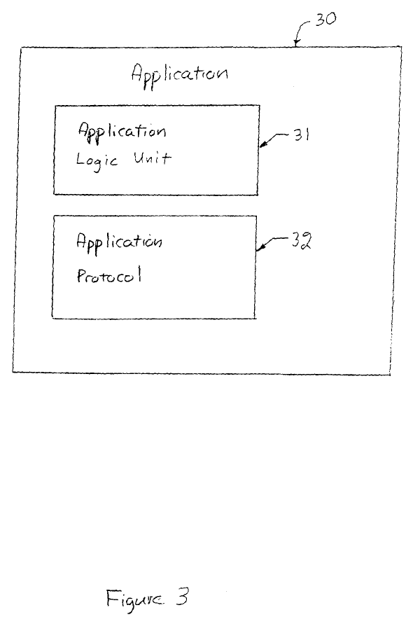

Figure 3 is a block diagram depicting the architecture of an application program (application) (30) in accordance with the present invention. The application typically runs on a terminal in communication with a smart device. Applications can be any implementation of the processing of data. Typical examples of applications include the debit functions in an electronic purse card, credit and add loyalty points in a frequent flyer program card, key generation in a security authorization card, memory retrieval in a medical history card, or security and memory functions common to many card implementations.

The application (30) of the present invention is segregated into two categories of software to form the application. The application (30) is composed of an application logic unit (31) and an application protocol (32). The application logic unit is the logic of the application, independent of the hardware implementation. The application protocol is a hardware specific component of the application and provides the data and rules necessary to implement the logic of the application protocol on a specific hardware implementation.

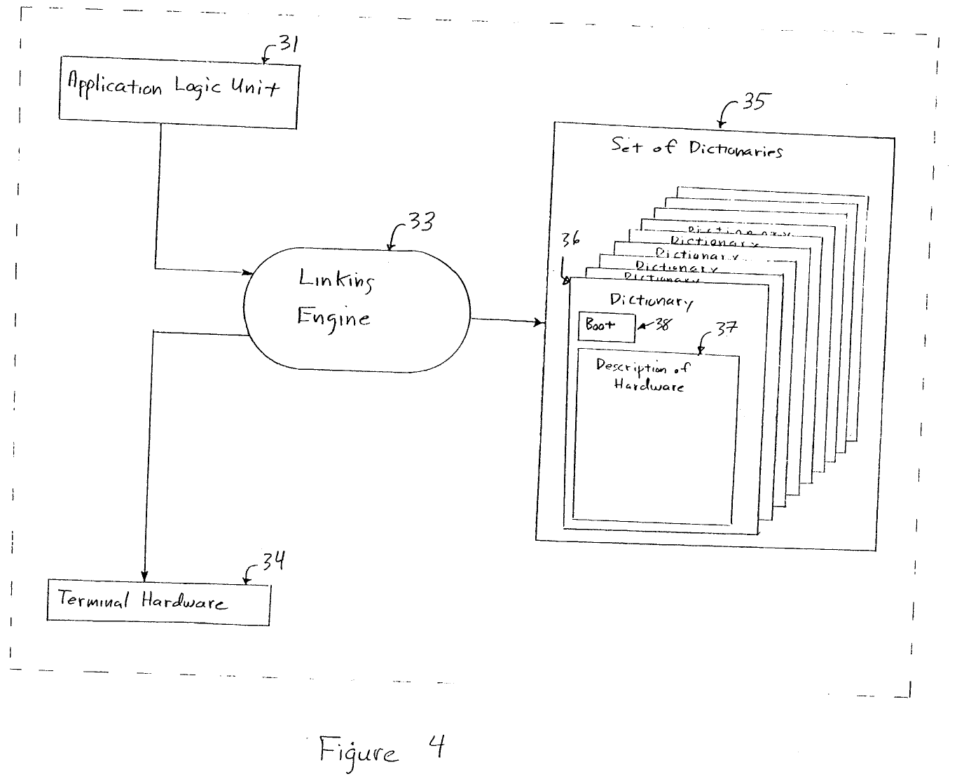

Figure 4 is a block diagram of the architecture of the application logic unit (31), linking engine (33) and terminal hardware (34). The application logic unit interacts with the linking engine to link an application protocol to the application logic unit. The linking engine interacts with a set of dictionaries (35) containing at least one dictionary (36). A dictionary (36) includes a description (37) relating to the terminal hardware (34) and to the smart card hardware (not shown). More particularly, the dictionary includes a series of verbs (not shown). The verbs are described in the body of the dictionary, the description being the definition of the verb. The definition of the verb is the hardware specific component of the application. The set of dictionaries (35) are specified in a boot file (38). The boot file is used by the linking engine (33) in testing the dictionary to determine whether that dictionary is the appropriate dictionary for the smart device and terminal present at the run time of the application. The appropriate dictionary is used as the application protocol which, when linked to the application logic unit, provides the hardware specific component of the application.

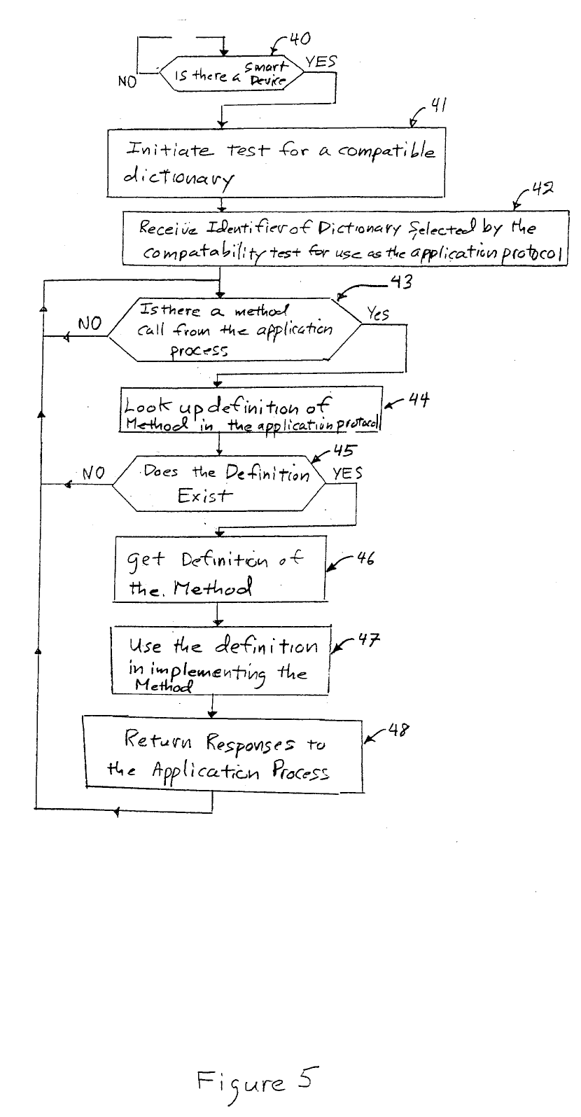

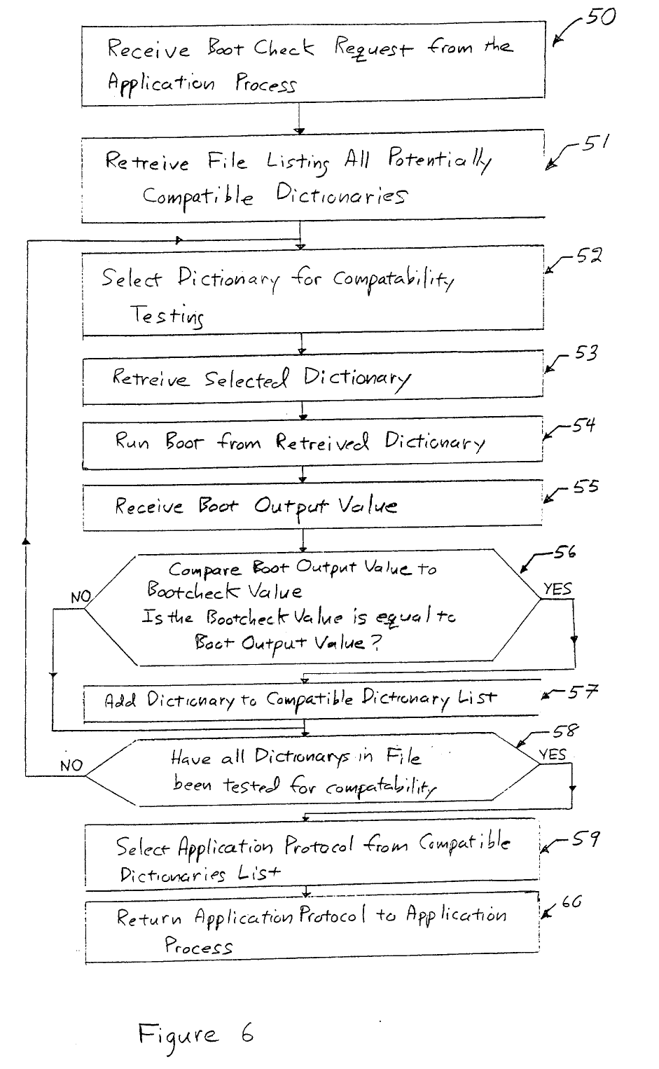

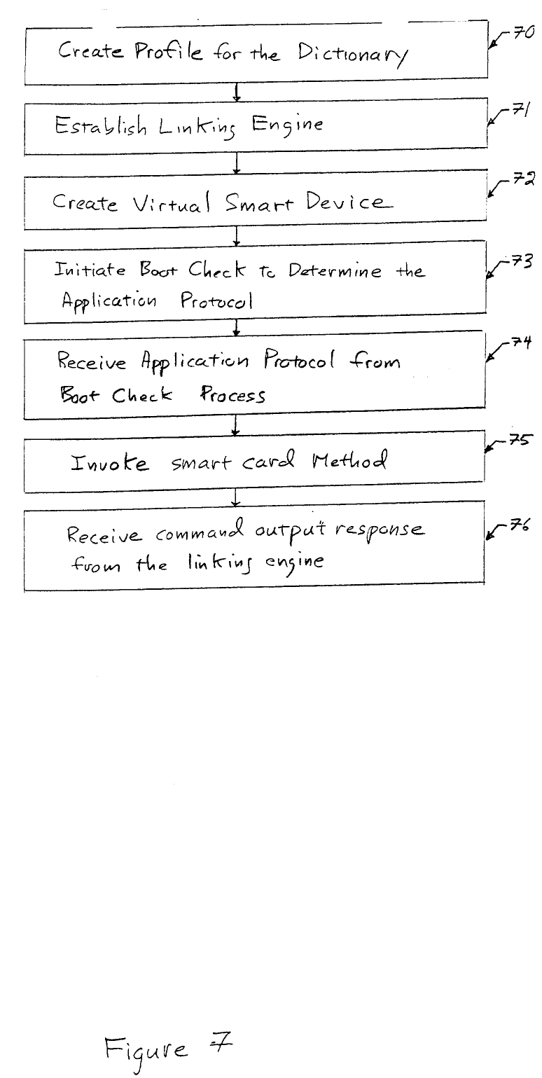

Figure 5 is a flow chart of the process the linking engine utilizes in running an application. In the presently preferred embodiment of the present invention the linking engine has been established and the application logic unit has initiated a boot check request prior to step (40), as described below in connection with Figure 7. At step (40) the linking engine waits for an indication that a smart device is in communication with the terminal. When a positive indication is received, i.e. when there is a smart device in communication with the terminal, the linking engine proceeds to step (41) to initiate a compatibility test for the dictionary to use as the application protocol. The process of selecting a dictionary for use as the application protocol is described below in connection with Figure 6. At step (42) the linking engine receives from the application protocol selection process the identifier of the compatible dictionary to use as the application protocol. The dictionary corresponding to the identifier is used as the application protocol. The linking engine then proceeds to step (43) to wait for a method call from the application logic unit.

In response to a method call from the application logic unit the linking engine proceeds to step (44) to look-up the method in the application protocol. At step (45) the linking engine determines whether a verb corresponding to the method exists in the application protocol. If the verb does not exist, the linking engine returns to step (44) to wait for a method call from the application logic unit. If the verb does exist in the application protocol, the linking engine proceeds to step (46) where the linking engine retrieves the definition from the application protocol and links the definition to the method call from the application logic unit. The linking engine then uses the verb"s definition at step (47) in executing the method call from the application logic unit. The description in the application protocol of the hardware is used to generate responses to the method call. The responses generated at step (47) from executing the method call according to the rules and data of the definition are then returned to the application logic unit at step (48). The linking engine returns to step (43) to wait for a method call from the application logic unit.

The linking engine may return a critical fault to the application logic unit in response to any condition which jeopardizes the proper execution of the application logic unit. The conditions which may give rise to a critical fault include the absence from the application protocol of a critical definition, absence from the application protocol of critical rules or data, absence of critical data from the application logic unit being passed to the method call, problems with the data used in the method call, or an inappropriate responses to executing the method call. In the preferred embodiment of the present invention, the conditions that trigger a critical fault are included in the application protocol.

Figure 6 is a flow chart illustrating the process used by the linking engine in selecting a dictionary for use as the application protocol with a given terminal and smart device. At step (50) the linking engine receives a boot check request, or dictionary selection request, from an application logic unit. In response, at step (51) the linking engine retrieves a list of potentially compatible dictionaries. In the presently preferred embodiment of the present invention, the list of potentially compatible dictionaries includes those dictionaries specified as potentially compatible with the application logic unit, the terminal and the smart device. More preferably, the dictionaries included on list of potentially compatible dictionaries are pre-selected to include dictionaries that are compatible with the terminal and application logic unit. In such a case, the list of dictionaries is inclusive of all the dictionaries that may be needed to provide a description compatible with any smart devices available for use with the application and terminal.

The list of dictionaries is located on a file separate from the application logic unit. This file is referred to as the boot file. As the boot file is separate from the application logic unit this file can be updated to add dictionaries, as when a new smart device is introduced, without the need to modify the application logic unit. Additionally, the boot file includes an address specifying where to find the dictionary. Depending on the implementation of the terminal and smart device the dictionary can be located on a computer accessible by the terminal through a network or Internet connection, or the dictionary can be stored in the memory of the smart device. When the terminal is able to connect to a network, or to the Internet, storing the dictionary remote from the smart device reduces the memory requirements of the smart device. Additionally, remote storage of the dictionary allows additional dictionaries to be added to the boot file without having to download dictionaries to the smart device. Remote storage of the dictionary also allows the dictionary to be modified, should this deem desirable. Alternatively, storage of the dictionary on the smart device provides additional assurance that the dictionary has not been modified, especially when the dictionary is stored in write resistant memory. Storage of the dictionary on the smart device allows access of the dictionary when the terminal is not able to access a network, or the Internet. In one embodiment of the present invention, a core set of dictionaries is stored on the card and an enhanced set of dictionaries is stored in a remote file. The core dictionaries support the basic functionality of a given card. The enhanced dictionaries provide support to additional features available for use with the card. In this manner the card provides basic support common with off-line applications, in addition to providing enhanced functionality common with on-line applications.

At step (52) the linking engine selects one of the dictionaries listed in the boot file for compatibility testing. At step (53) the linking engine retrieves the dictionary selected at step (52). At step (54) the linking runs the boot to scan the retrieved dictionary to retrieve selected segments of the dictionary for input to the linking engine for compatibility testing. The boot file provides a description of the segments of the dictionary to be scanned and used in generating the output value of the compatibility test. The linking engine generates an output value based on the specified dictionary information. At step (55) the linking engine receives the output value from the compatibility test. The output value is compared to a bootcheck value at step (56). In the preferred embodiment of the present invention the bootcheck value is a standard value common for all smart devices. The bootcheck value may be stored in the application logic unit, the boot file, or the dictionary. If the output value is the same as the bootcheck value the linking engine adds the dictionary corresponding to the output value to a list of compatible dictionaries at step (57). The linking engine then proceeds to step (58). If at step (56) the output value is not the same as the bootcheck value the linking engine proceeds to step (58) without adding the dictionary corresponding to the boot to the compatible dictionary list.

Different applications and smart devices may require testing of multiple functionalities of the dictionary and the card. In such instances, there may be a plurality of bootcheck values corresponding to the multiple functionalities to be tested for compatibility. In the preferred embodiment of the present invention, the bootcheck value corresponding to each functionality tested will be common for all smart devices. Optionally, the linking may generate a plurality of output values based on the boot file, the output values being dependent on the smart device. At step (55) the linking engine receives the output values from the compatibility test. The output values are compared to the corresponding bootcheck values at step (56). If the output value is the same as the bootcheck value corresponding to the same functionality being tested the linking engine adds the dictionary corresponding to the output value to a list of compatible dictionaries at step (57). The linking engine then proceeds to step (58). If at step (56) the output value is not equal to the bootcheck value the linking engine proceeds to step (58).

At step (59) the lining engine checks whether all of the dictionaries listed in the boot file have been tested for compatibility. If all of the dictionaries have not been tested, the system returns to step (52). If all of the dictionaries have been tested, the linking engine proceeds to step (59). In the presently preferred embodiment of the present invention the linking engine tests all of the dictionaries and compares the output value form each dictionary against the bootcheck value. All the dictionaries having an output value equal to the bootcheck value are added to the list of compatible dictionaries.

Optionally, the linking engine can compare the dictionaries on the list of compatible dictionaries to select which dictionary to specify as the application protocol. Selection could be based on the smallest file size of the dictionary, the most features of the dictionary, or some other criteria. Alternatively, as all of the dictionaries are suitable for use as the application protocol, the linking engine may select any of the dictionaries from the list at random. This selection process, by any suitable process, is performed at step (59).

At step (60) the linking engine returns the identifier of the dictionary selected for use as the application protocol to the application logic unit.

Figure 7 is flow chart illustrating the process of running an application in accordance with the present invention. At step (70) the application logic unit begins the process of creating a virtual smart device by creating a profile for the dictionary. At step (71) the application logic unit establishes the linking engine to run on top of any software layer which interacts with the terminal hardware. In the preferred embodiment of the present invention the linking engine is stored on the terminal. Step (71) makes an initial call to the linking engine. At step (72) the virtual smart device is created as running on top of the terminal hardware layer of software and referencing the profile for the dictionary. Creating a virtual smart device allows the application logic unit to access the linking engine to link the application logic unit to an application protocol.

At step (73) the application logic unit initiates a boot check to find the dictionary to be used as the application protocol. The boot check process is described in detail above in connection with Figure 6. The dictionary selected during the boot check process is returned at step (74) and is used as the application protocol.

At step (75) the application logic unit invokes a method call. A method call can be any logical process to access or manipulate data on either the smart device or the terminal. Checking the balance in the card"s electronic purse is one example of a method call. Another example of a method call is the debiting of loyalty points in a smart card. As described in connection with Figure 5, the linking engine receives the invoked method call at step (43) and uses the dictionary definition of the method in running the application. Based on the definition contained in the dictionary, at step (47) the linking engine runs a sequence of smart device commands. These commands output responses based on the data from the card and the dictionary. The linking engine returns the responses related to the smart device commands to the application logic unit at step (48) of Figure 5. The application logic unit receives the command output responses at step (76). The application logic unit then continues by either invoking additional method calls, in which the process begins again at step (75), or by ending.

Example

A source code example of an application logic unit and the appropriate dictionary used as the application protocol, in accordance with the present invention, is given below. The boot file for testing compatibility between a dictionary and the application logic unit is also provided. The example application logic unit is written in Java^{TM} and the related application protocol and boot files are written in XML. In the presently preferred embodiment, XML is chosen for its suitability in providing descriptions of the hardware implementation.

In the examples below the line numbers (A1, A2, A3, … B1,B2, B3, … C1, C2, C3,….) are only used for discussion purposes and are not part of the source code. These line numbers refer only to the line as printed herein and not to a line of the source code.

APPLICATION LOGIC UNIT

The Java example below of an application logic unit is for a loyalty application, as indicated by line A1. This example of an application logic unit checks the loyalty points stored on the smart card, determines whether additional loyalty points are to be credited and added to the loyalty points total, and whether loyalty points are being redeemed and debited from the loyalty points total. At line A31 the string variable for the dictionary is created. The main part of the program begins at line A190. A207- A215, A226 and A232-A233 a virtual smart card is created to access the linking engine. At line A207 the boot file is imported to the application as an argument. The boot argument is then used at line A211 in creating the profile instance of the smart card. At line A237-A238 the process of checking the boot find the appropriate dictionary is initiated. At lines A264 and A265 the dictionary determined to be the appropriate dictionary, as described above in connection with Figure 6, is used as the application protocol. Once the dictionary used as the application protocol is specified, the application logic unit is then free to implement the logic of the application using the hardware specific information and rules specified in the dictionary. Accordingly, at line A288 the application begins the logic of implementing a loyalty application. The logic of implementing the loyalty application continues through to line A773. The logic of the application includes security check methods, balance check methods, methods to redeem and award loyalty points, as well as methods to report and collect information form the cardholder and the merchant sponsoring the loyalty program.

For example, from line A288 through line A360 the application logic unit provides a security check procedure.

As an additional example, the application logic unit reads the value of the transaction for crediting loyalty points to the cardholder from line A367 through line A375. The application logic unit prompts the entering of the amount of the transaction at lines A370-A372. The amount of the transaction is read at line A374.

The example application logic unit contains four verbs: GetCardInfo, verify, TransactionAward, and TransactionRedeem.

The first method call for the verb GetCardInfo is at line A410. The first method call for the verb verify is at line A657. The first method call for the verb TransactionAward is at line A533. The first method call for the verb TransactionRedeem is at line A576. The first method call for all four of the verbs used in the application logic unit are after the application logic unit has specified the dictionary to be used as the application protocol. In this manner the definitions of the verbs in the application protocol are linked to the method in the application logic unit prior to the invocation of the method call.

[image]

[image]

[image]

[image]

[image]

[image]

[image]

[image]

[image]

[image]

[image]

[image]

[image]

[image]

[image]

[image]

[image]

APPLICATION PROTCOL

The example of an application protocol listed below from line B1 through B803 provides the data and rules for implementing the logic of the application logic unit listed above on a Gemplus^{TM} GemXplore98^{TM} smart card. The card the dictionary is compatible with is specified at line B6. This example dictionary includes definitions on four verbs: GetCardInfo, verify, TransactionAward, and TransactionRedeem.

At line B10 the verb GetCardInfo is specified. The two method calls for the verb GetCardInfo in the example of the application logic unit, described above, are at lines A410 and A413. The definition of the verb GetCardInfo is provided at lines B11 through B293. Lines B15 through B57 list data for the implementation of the verb GetCardInfo. Lines B59 through B293 list the rules used in implementing the verb GetCardInfo on the Gemplus GemXplore98 smart card.

At line B295 the verb verify is specified. The definition corresponding to the verb verify is provided at lines B295 through B326. Lines B296 through B302 list data for the implementation of the verb verify. Lines B303 through B326 list the rules used in implementing the verb verify on the Gemplus GemXplore98 smart card. The only method call for the verb verify in the above example of an application logic unit is at line A657.

At line B328 the verb TransactionAward is specified. The definition of the verb TransactionAward is provided at lines B328 through B554. Lines B332 through B377 list data for the implementation of the verb TransactionAward. Lines B379 through B554 list the rules used in implementing the verb TransactionAward on the Gemplus GemXplore98 smart card. The only method call for the verb TransactionAward in the above example of an application logic unit is at line A533.

At line B555 the verb TransactionRedeem is specified. The definition of the verb TransactionRedeem is provided at lines B555 through B785. Lines B559 through B595 list data for the implementation of the verb TransactionRedeem. Lines B597 through B803 list the rules used in implementing the verb TransactionRedeem on the Gemplus GemXplore98 smart card. Lines B597 through B785 list the rules used in implementing the verb TransactionRedeem on the Gemplus GemXplore98 smart card. The only method call for the verb TransactionRedeem in the above example of an application logic unit is at line A576.

In the definitions of the four verbs contained in the application protocol, the data and rules used to implement the definition of the verb is particular to the smart device, in this example a Gemplus GemXplore98 smart card. Definitions for the same four verbs: GetCardInfo, verify, TransactionAward, and TransactionRedeem, for implementation with another smart device in connection with the example application logic unit would typically have definitions that differed from the example definitions presented. The definitions could differ in either the data, the rules, or both.

[image]

[image]

[image]

[image]

[image]

[image]

[image]

[image]

[image]

[image]

[image]

[image]

[image]

[image]

[image]

APPLICATION BOOT

The example of a boot file listed below from line C1 through line C177 provides the data and rules for testing a dictionary for compatibility with the example application logic unit listed above. The rules described in the boot file for compatibility testing allow two types of smart cards to be approved as compatible with the example application logic unit. Specifically, the example boot file allows Gemplus GemXplore98, and Gemplus GemClub^{TM} smart cards to be scanned and approved for compatibility with the application logic unit. The procedure implemented according to the rules of the boot file yields a unique, predetermined value for each of these three compatible smart cards. This unique predetermined value is returned to the linking engine as the output value of the boot process and is used to test the compatibility of the card, as described in connection with Figure 6. Additionally, the boot file includes an address where the dictionaries can be retrieved for compatibility testing.

[image]

[image]

[image]

[image]

While the application protocol and boot file examples described above are written in XML, alternate embodiments of the present invention could use different versions of XML, or different languages or implementations, to provide the description. Additionally, the boot file and application protocol need not be written in the same language, as is done in the present example.

While the application logic unit in the above example is written in Java, alternate embodiments of the present invention could use other computer languages for the implementation of the logic of the application.

The present invention allows a developer of application software to write an application logic unit without concern for the particular hardware implementation of readers, computers, or smart cards. Through the linking engine, the present invention retrieves the hardware specific description of the logical processes of the application logic unit. The linking engine matches the identifiers specifying the hardware used, the reader, smart card and any computer, to the process called for the in application logic unit. Accordingly, the present invention has the advantage of allowing an application developer to write applications that may be implemented on any combination of terminal or smart device with an existing dictionary for the combination of terminal and smart device. The present invention reduces the burden on the memory of the terminal by allowing hardware specific portions of the application to be downloaded for a specific smart device, thereby eliminating the need to store hardware specific functional elements of the application related to the smart device.

The present invention allows other smart cards, or other types of smart devices, to be added as compatible with the application logic unit by either adding to the existing boot file, or using a new boot file with the scanning information for the new smart card. In this manner the present invention, as illustrated by the examples contained herein, provides enhanced flexibility and interoperability among different smart device types through the addition of boot files and dictionaries without the need to modify the existing application logic unit.

While the preferred embodiment of the present invention links the application protocol to the application logic unit, alternate embodiments of the present invention may perform the linking operation prior to run time.

What is Claimed is:

1. A terminal for running an application program for processing data in connection with a smart device, comprising:
an application logic unit providing the hardware independent description of the logic of the application program; and
an identifier specifying the location of an application protocol providing the hardware description of the application program.

2. The terminal of claim 1, wherein the terminal further comprises:
a means for linking the application logic unit to the application protocol to implement the logical processes of the application logic unit in connection with the smart device.

3. The terminal of claim 1, wherein the identifier corresponds to a memory location on the smart device.

4. The terminal of claim 1, wherein the identifier corresponds to a memory location accessible through a network connection.

5. The terminal of claim 1, wherein the identifier corresponds to a memory location on the terminal.

6. The terminal of claim 2, wherein the means for linking performs a compatibility test prior to linking the application protocol to the application logic unit.

7. The terminal of claim 6, wherein the means for linking performs the compatibility test on a plurality of dictionaries prior to selecting a dictionary for sue as the application protocol.

8. A smart device used in connection with a terminal for running an application program for processing data, comprising:
a memory unit; and
an identifier located in the memory unit specifying the location of an application protocol, the application protocol providing the hardware description of the application program.

9. A method for running an application program for processing data in connection with a smart device, the method comprising the steps of:
initiating the running of an application logic unit;
initiating the testing of at least one dictionary for compatibility with the hardware implementation,
selecting a dictionary for use as the application protocol based on the outcome of the compatibility test;
linking the selected dictionary to the application logic unit for use as the application protocol; and
implementing the logic of the application logic unit using the definitions contained in the application protocol.

10. A method of linking a dictionary to an application logic unit to implement the application logic unit, comprising:
receiving a request from an application logic unit to find a dictionary compatible with the hardware implementation present at the time the application logic unit makes the request;
retrieving a list including at least one identifier of a potentially compatible dictionary;
selecting a dictionary for compatibility testing from the list of potentially compatible dictionaries;
retrieving the selected dictionary;
running a boot to scan the dictionary for segments of the dictionary used in the compatibility test;
generating a output value corresponding to the selected dictionary;
comparing the output value to a bootcheck value;
including the selected dictionary on a compatible dictionary list if the output value is equivalent to the bootcheck value;
selecting a dictionary from the compatible dictionary list for use as the application protocol; and
linking the dictionary selected from the compatible dictionary list to the application logic unit for use in implementing the application logic unit.

11. The method of linking the application logic unit to the application protocol of claim 10, wherein at least one additional dictionary is selected for compatibility testing.

12. The method of linking the application logic unit to the application protocol of claim 11, wherein additional dictionaries are included on the compatible dictionary list when the corresponding output value of the tested dictionary is equivalent to the bootcheck value.

13. The method of linking the application logic unit to the application protocol of claim 11 wherein all the dictionaries on the list of potentially compatible dictionaries are tested for compatibility.

14. The method of linking the application logic unit to the application protocol of claim 11 wherein all dictionaries are included on the compatible dictionary list where the dictionary output value is equivalent to the bootcheck value.

15. The method of linking the application logic unit to the application protocol of claim 13 wherein all dictionaries are included on the compatible dictionary list where the dictionary output value is equivalent to the bootcheck value.

16. A method of running an application program, comprising the steps of:
creating a profile for the application protocol;
establishing a linking engine;
initiating a test of at least one dictionary for compatibility with the hardware implementation and an application logic unit;
selecting a dictionary for use of as the application protocol based on the outcome of the compatibility test;
invoking at least one smart device method; and
receiving an output response based on a definition of the invoked smart device method, the definition of the invoked smart card method contained in the application protocol.

17. A application program for processing data in connection with data processed on a smart device, comprising:
an application logic unit specifying the logic performed in processing the data, the application logic unit including at least one smart device method; and
an application protocol including a definition of the smart device method, the definition providing the hardware specific component of the smart device method.

18. The application program of claim 17, further comprising a boot file, the boot file specifying segments of a dictionary tested for compatibility as the application protocol for the application logic unit.

19. The application program of claim 17, wherein the application protocol is linked to the application logic unit by a linking engine.

20. The application program of claim 19, wherein the linking engine performs a compatibility test prior to linking the application protocol to the application logic unit.
